(19) United States
(12) Patent Application Publication
(10) Pub. No.: US 2026/0016640 A1
(43) Pub. Date: Jan. 15, 2026

(54) OPTICAL CROSS-CONNECT DEVICE

(71) Applicant: Nippon Telegraph and Telephone Corporation, Tokyo (JP)

(72) Inventors: Yoshiteru ABE, Musashino-shi, Tokyo (JP); Chisato FUKAI, Musashino-shi, Tokyo (JP); Kazunori KATAYAMA, Musashino-shi, Tokyo (JP)

(21) Appl. No.: 18/995,210

(22) PCT Filed: Aug. 1, 2022
(86) PCT No.: PCT/JP2022/029471

§ 371 Date: Jan. 16, 2025

(51) Int. Cl. G02B 6/35

(52) U.S. Cl. CPC G02B 6/356; G02B 6/3504; G02B 6/3568

(57) ABSTRACT

An optical cross-connect includes: first to fourth optical switches connected to first to fourth optical fiber cores on four routes; and optical fibers that connect the optical switches between each other. Each of the optical switches includes a first ferrule which is a ferrule disposed to expose each of the optical fiber cores at end surfaces and at which each of the optical fiber cores on a route is disposed, a second ferrule which is the ferrule and at which each of the optical fiber cores that connect the optical switches between each other is disposed, and a sleeve that supports the first ferrule and the second ferrule inside such that the end surfaces of the first ferrule and the second ferrule face each other and the first ferrule and the second ferrule are rotatable relative to each other along an inner wall of the sleeve.

### TECHNICAL FIELD

The present invention relates to an optical cross-connect.

### BACKGROUND ART

A multistage loop network configuration has been proposed as one optical access network configuration (see Non-Patent Literature 1). In a multistage loop network configuration, since an optical access network is configured of a plurality of loops, an advantage is that a redundant path is easily secured. In the multistage loop network configurations, it has been proposed to install a core switching function of switching a path of an optical fiber at a point where a plurality of loops meet in a multistage loop network in order to meet an unpredictable demand for an optical fiber core.

The core switching function can be realized by an optical cross-connect that switches a signal path. Configurations of the optical cross-connect in a multistage loop network include an example in which a plurality of optical switches capable of switching an optical path without converting an optical signal into an electrical signal are used, and the optical switches are connected by an optical fiber. Various systems have been suggested for an all-optical switch that performs path switching while keeping an optical signal as it is, but a mechanical optical switch that controls abutment between optical fibers or optical connectors with a robot arm, a motor, or the like is superior to other systems in terms of low loss, low wavelength dependence, multi-port properties, and a self-holding function of holding a switching state when power supply is cut off.

As the mechanical optical switch, there has been proposed a mechanical optical switch in which a cylindrical ferrule used in a single core optical connector is rotated by a motor for the purpose of realizing a core switching function in an outdoor environment having a multistage loop network configuration (see Non Patent Literature 2). The mechanical optical switch can drive the motor by optical power supply without using a commercial power supply.

### CITATION LIST

### Non Patent Literature

Non Patent Literature 1: Shingo Ohno, Chihiro Kito, Kunihiro Toge, Shigekatsu Tetsutani, Shoichi Furujo, “Optical Access Network Design Based on Concatenated Loop Topology”, The transactions of the Institute of Electronics, Information and Communication Engineers B Vol. J104-B No. 11 pp. 929-937, 2021
Non Patent Literature 2: Chisato Fukai, Yoshiteru Abe, Kazunori Katayama, “Rotation mechanism of multi-core fiber on optical switching for remote operated optical fiber switching node”, The Institute of Electronics, Information and Communication Engineers General Conference, B-13-18, 2021

### SUMMARY OF INVENTION

### Technical Problem

Incidentally, because the optical cross-connect is provided at a point where two or more loops meet in the multistage loop network configuration, it needs to be capable of mutually switching connections between optical fiber cores on an even number of four or more routes.

The present invention is proposed in view of the above circumstances, and an object of the present invention is to provide an optical cross-connect that is provided at a point where two or more loops meet in a multistage loop network configuration and is capable of mutually switching connections of optical fiber cores on four or more routes.

### Solution to Problem

In order to solve the above-described problem, an optical cross-connect according to an aspect of the present invention is an optical cross-connect that switches connections between optical fiber cores on an even number of four or more routes, the optical cross-connect including: optical switches connected to the respective optical fiber cores on the individual routes; and optical fibers that connect the optical switches between each other. Each of the optical switches includes a first ferrule which is a ferrule disposed to expose each of the optical fiber cores at end surfaces and at which each of the optical fiber cores on a route that is connected to each of the optical switches is disposed, a second ferrule which is the ferrule and at which each of the optical fibers that connect the optical switches between each other and are connected to the optical switches is disposed, and a sleeve that supports the first ferrule and the second ferrule inside such that the end surfaces of the first ferrule and the second ferrule face each other and the first ferrule and the second ferrule are rotatable relative to each other along an inner wall of the sleeve.

### Advantageous Effects of Invention

According to this invention, it is possible to provide an optical cross-connect that is provided at a point where two or more loops meet in a multistage loop network configuration and is capable of mutually switching connections of optical fiber cores on an even number of four or more routes.

### BRIEF DESCRIPTION OF DRAWINGS

FIG. 1 is a view illustrating a schematic configuration of an optical cross-connect.

FIG. 2A is a cross-sectional view of a first optical switch.

FIG. 2B is a cross-sectional view of the first optical switch.

FIG. 3 is a view for describing an operation of the first optical switch.

FIG. 4 is a view illustrating a first connection state in the optical cross-connect.

FIG. 5 is a view illustrating a second connection state in the optical cross-connect.

FIG. 6 is a view illustrating a schematic configuration of the optical cross-connect in a second connection state.

FIG. 7A is a cross-sectional view of the first optical switch in the second connection state.

FIG. 7B is a cross-sectional view of the first optical switch in the second connection state.

### DESCRIPTION OF EMBODIMENTS

Hereinafter, an embodiment of an optical cross-connect will be described in detail with reference to the drawings. The optical cross-connect according to the present embodiment is assumed to be capable of switching optical fiber cores on four routes to each other at a point where two loops meet in a multistage loop network configuration. However, in the case of an even number of four or more routes at a point where two or more loops meet, it is possible to similarly realize not only the optical fiber cores on four routes at the point where the two loops meet but also a configuration in which the optical fiber cores are switchable to each other.

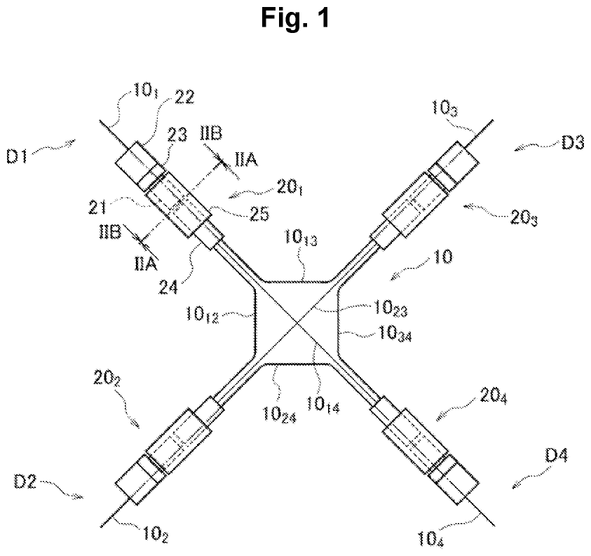

FIG. 1 is a view illustrating a schematic configuration of the optical cross-connect according to the present embodiment. In the optical cross-connect, first to fourth optical fiber cores 10₁ to 10₄ on four routes of a first route D1 to a fourth route D4 are connected to input sides of first to fourth optical switches 20₁ to 20₄, respectively. Specifically, the first optical fiber core 10₁ on the first route D1 is connected to the first optical switch 20₁, the second optical fiber core 10₂ on the second route D2 is connected to the second optical switch 20₂, the third optical fiber core 10₃ on the third route D3 is connected to the third optical switch 20₃, and the fourth optical fiber core 10₄ on the fourth route D4 is connected to the fourth optical switch 20₄.

The output sides of the first to fourth optical switches 20₁ to 20₄ are connected to each other by optical fibers 10. Specifically, the first optical switch 20₁ is connected to the second optical switch 20₂ by an optical fiber 10₁₂, to the third optical switch 20₃ by an optical fiber 10₁₃, and to the fourth optical switch 20₄ by an optical fiber 10₁₄. The second optical switch 20₂ is connected to the third optical switch 20₃ by an optical fiber 10₂₃ and to the fourth optical switch 20₄ by an optical fiber 10₂₄. The third optical switch 20₃ is connected to the fourth optical switch 20₄ by an optical fiber 10₃₄.

In the first optical switch 20₁, a first ferrule 21 on the input side to which the first optical fiber core 10₁ is connected and a second ferrule 24 on the output side to which the three optical fibers 10₁₂ to 10₁₄ connected to the other optical switches are connected are inserted into a sleeve 25 from both ends thereof such that end surfaces of the ferrules face each other. In the sleeve 25, an end surface 21a of the first ferrule 21 and an end surface 24a of the second ferrule 24 may abut against each other and be in contact with each other or may be separated to form a predetermined gap. A ferrule constituting the first ferrule 21 and the second ferrule 24 has a cylindrical side surface and an end surface which is formed at an end portion of the side surface and is orthogonal to the side surface, and the ferrule is disposed to expose an optical fiber core at the end surfaces. The end surfaces may be polished together with the optical fiber core. The ferrule may be made of a resin or may be made of a metal or another material.

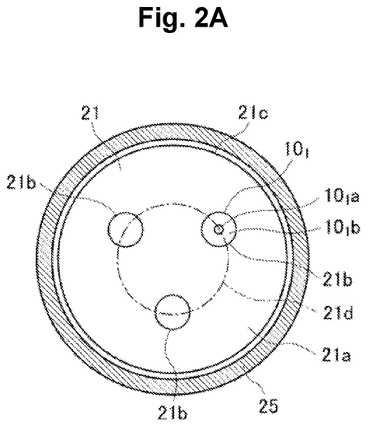

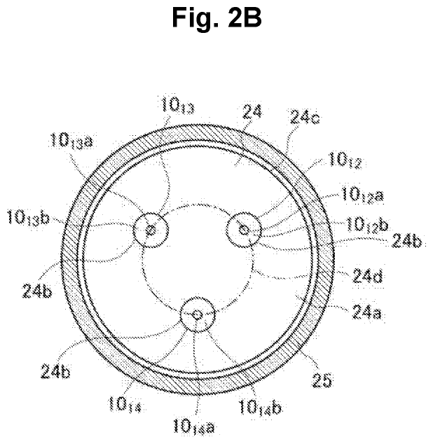

FIGS. 2A and 2B are cross-sectional views of the first optical switch 20₁. These cross-sectional views illustrate cross sections of the first optical switch 20₁ cut along a cutting line passing between the end surface 21a of the first ferrule 21 and the end surface 24a of the second ferrule 24 which face each other inside the sleeve 25 in FIG. 1. FIG. 2A illustrates the end surface 21a of the first ferrule 21. The first ferrule 21 has a cylindrical side surface, and the end surface 21a is formed to be orthogonal to the side surface at an end portion of the side surface. The end surface 21a has three holes 21b formed at symmetrical positions in a circumferential direction, that is, positions at equal intervals in the circumferential direction, on a circumference 21d having a predetermined diameter in the end surface 21a, the circumference 21d being concentric with a circumference 21c formed on a circumferential edge intersecting the side surface. The three holes 21b have a predetermined diameter, penetrate the first ferrule 21, and open in the end surface 21a. The first optical fiber core 10₁ is inserted into one hole 21b therein from the back side toward the end surface 21a through the first ferrule 21 and is fixed with an adhesive to expose an end surface of the first optical fiber core 10₁. The first optical fiber core 10₁ includes a core 10₁a and a clad 10₁b.

FIG. 2B illustrates the end surface 24a of the second ferrule 24. The second ferrule 24 has a cylindrical side surface, and the end surface 24a is formed to be orthogonal to the side surface at an end portion of the side surface. The end surface 24a has three holes 24b formed at symmetrical positions in a circumferential direction on a circumference 24d having a predetermined diameter in the end surface 24a, the circumference 21d being concentric with a circumference 24c formed on a circumferential edge intersecting the side surface. The three holes 24b have a predetermined diameter, penetrate the second ferrule 24, and open in the end surface 24a. The optical fiber 10₁₂ connected to the second optical switch 20₂, the optical fiber 10₁₃ connected to the third optical switch 20₃, and the optical fiber 10₁₄ connected to the fourth optical switch 20₄ are arranged in that order in the three holes 24b in the counterclockwise direction. The predetermined diameter of the circumference 24d on which the three holes 24b are formed in the end surface 24a corresponds to the predetermined diameter of the circumference 21d of the first ferrule 21. The three optical fibers 10₁₂ to 10₁₄ are each inserted into the holes 24b from the back side toward the end surface 24a through the second ferrule 24 and are fixed with an adhesive to expose end surfaces of cores of the optical fibers 10₁₂ to 10₁₄. The three optical fibers 10₁₂ to 10₁₄ include cores 10₁₂a to 10₁₄a and clads 10₁₂b to 10₁₄b, respectively.

The sleeve 25 has an inner diameter slightly larger than outer diameters of the side surfaces of the first ferrule 21 and the second ferrule 24. The sleeve 25 supports the first ferrule 21 and the second ferrule 24 inserted from both ends of the sleeve to be rotatable relative to each other along an inner wall of the sleeve. Note that the second ferrule 24 may be fixed in a rotation direction along the inner wall of the sleeve 25. The sleeve 25 may be made of a resin or may be made of a metal or another material.

With reference to FIG. 1 again, the motor 22 is provided to be coaxial with the first ferrule 21 and face the end surface 21a of the first ferrule 21 with the first ferrule 21 interposed therebetween. The motor 22 has a cylindrical side surface having substantially the same diameter as the sleeve 25, and a flange 23 that surrounds a base of the first ferrule 21 and extends toward the sleeve 25 is formed at an end of the side surface facing the first ferrule 21. The motor 22 rotationally drives the first ferrule 21 via a rotary drive device of the flange 23. The rotary drive device may rotate the first ferrule 21 by directly connecting the flange 23 and the motor 22 and directly transmitting rotation of the motor 22 to the flange 23 or may rotate the first ferrule 21 by indirectly transmitting the rotation of the motor 22 to the flange 23 by interposing a gear between the flange 23 and the motor 22. The motor 22 may be driven by optically supplied electric power.

The motor 22 rotationally drives the first ferrule 21 to switch connections between the first optical fiber core 10₁ and the three optical fibers 10₁₂ to 10₁₄. The motor 22 rotationally drives the coaxial first ferrule 21 along the inner wall of the sleeve 25 such that the end surface 21a of the first ferrule 21 rotates relatively with respect to the end surface 24a of the second ferrule 24. The first optical fiber core 10₁ disposed at the end surface 21a of the first ferrule 21 and any one of the three optical fibers 10₁₂ to 10₁₄ disposed at the end surface 24a of the second ferrule 24 are abutted on each other to connect the first optical fiber core 10₁ and any one of the three optical fibers 10₁₂ to 10₁₄. In FIGS. 2A and 2B, the first optical fiber core 10₁ and the optical fiber 10₁₃ connected to the third optical switch 20₃ are abutted on each other and connected.

The optical cross-connect is supported by a suitable substrate. Some of the first to fourth optical fiber cores 10₁ to 10₄ on the first to fourth routes D1 to D4 constituting the optical cross-connect, the first to fourth optical switches 20₁ to 20₄, and the optical fibers 10₁₂ to 10₃₄ may be fixed to a surface of a substrate made of a resin such as polyimide with an adhesive and may be covered with a sheet made of a resin. In addition, the cores, the switches, and the optical fibers may be embedded in a sheet-shaped substrate made of a resin. The optical cross-connect may have flexibility together with a substrate to be fixed.

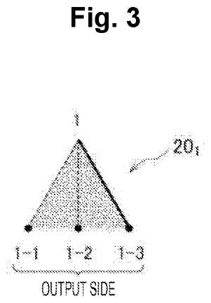

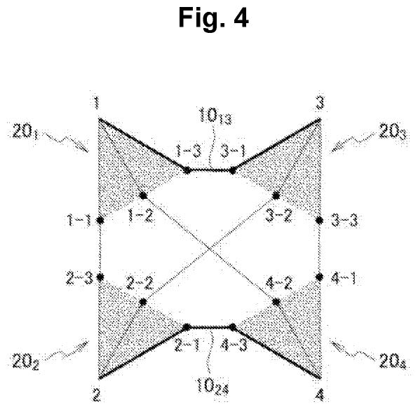

FIG. 3 is a view for describing an operation of the first optical switch 20₁. The first optical switch 20₁ constitutes a 1×3 optical switch having one port on the input side and three ports on the output side. In the first optical switch 20₁, the first optical fiber core 10₁ on the first route D1 is connected to a port 1 on the input side, and the three optical fibers 10₁₂, 10₁₄, and 10₁₃ connected to the second optical switch 20₂, the fourth optical switch 20₄, and the third optical switch 20₃ are connected to ports 1-1, 1-2, and 1-3 on the output side, respectively. Note that the order of connecting the optical fibers 10₁₂, 10₁₄, and 10₁₃ to the ports on the output side is based on FIG. 4 to be described below.

In the first optical switch 20₁, the motor 22 rotatably drives the first ferrule 21 to abut the first optical fiber core 10₁ disposed at the end surface 21a of the first ferrule 21 on any one of the three optical fibers 10₁₂ to 10₁₄ disposed at the end surface 24a of the second ferrule 24. The first optical fiber core 10₁ is connected to any one of the three optical fibers 10₁₂ to 10₁₄. In the drawing, it is illustrated that the port 1 on the input side and the port 1-3 on the output side are connected, and the first optical fiber core 10₁ and the optical fiber 10₁₃ connected to the third optical switch 20₃ are connected. Such control of the connection may follow a control signal sent to the first optical switch 20₁.

In FIGS. 2A, 2B, and 3, the first optical switch 20₁ of the optical cross-connect has been described, but the same applies to the other second to fourth optical switches 20₂ to 20₄. That is, in the second optical switch 20₂, the second optical fiber core 10₂ can be connected to any one of the three optical fibers 10₁₂, 10₂₃, and 10₂₄. In addition, the third optical switch 20₃ can connect the third optical fiber core 10₃ and any one of the three optical fibers 10₁₃, 10₂₃, and 10₃₄, and the fourth optical switch 20₄ can connect the fourth optical fiber core 10₄ and any one of the three optical fibers 10₁₄, 10₂₄, and 10₃₄.

FIG. 4 is a view illustrating a first connection state in the optical cross-connect. In the first connection state, the first route D1 and the third route D3 are connected, and the second route D2 and the fourth route D4 are connected. Specifically, in the first optical switch 20₁, the first optical fiber core 10₁ from the first route D1 which is connected to the port 1 on the input side is connected to the optical fiber 10₁₃ from the third optical switch 20₃ connected to the port 1-3 on the output side. In the third optical switch 20₃, the third optical fiber core 10₃ from the third route D3 which is connected to the port 3 on the input side is connected to the optical fiber 10₁₃ from the first optical switch 20₁ connected to the port 3-1 on the output side. Hence, the first route D1 and the third route D3 are connected through the first optical fiber core 10₁, the first optical switch 20₁, the optical fiber 10₁₃, the third optical switch 20₃, and the third optical fiber core 10₃.

In addition, in the second optical switch 20₂, the second optical fiber core 10₂ from the second route D2 which is connected to the port 2 on the input side is connected to the optical fiber 10₂₄ from the fourth optical switch 20₄ connected to the port 2-1 on the output side. In the fourth optical switch 20₄, the fourth optical fiber core 10₄ from the fourth route D4 which is connected to the port 4 on the input side is connected to the optical fiber 10₂₄ from the second optical switch 20₂ connected to a port 4-3 on the output side. Hence, the second route D2 and the fourth route D4 are connected through the second optical fiber core 10₂, the second optical switch 20₂, the optical fiber 10₂₄, the fourth optical switch 20₄, and the fourth optical fiber core 10₄.

Note that, in the optical cross-connect illustrated in FIG. 1, connection states of the first to fourth optical switches 20₁ to 20₄ are indicated by alternate long and short dash lines. In FIG. 1, it is confirmed that the first route D1 and the third route D3 are connected through the first optical fiber core 10₁, the first optical switch 20₁, the optical fiber 10₁₃, the third optical switch 20₃, and the third optical fiber core 10₃. In addition, it is confirmed that the second route D2 and the fourth route D4 are connected through the second optical fiber core 10₂, the second optical switch 20₂, the optical fiber 10₂₄, the fourth optical switch 20₄, and the fourth optical fiber core 10₄.

Such settings of the first connection state may follow control signals transmitted to the first to fourth optical switches 20₁ to 20₄. In addition, the settings in the first optical switch 20₁ to the fourth optical switch 20₄ may be performed by driving the motor 22 with the optically supplied electric power.

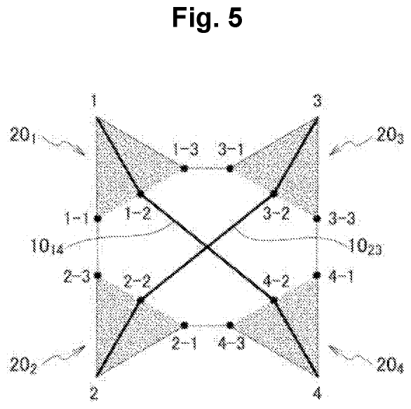

FIG. 5 is a view illustrating a second connection state in the optical cross-connect. In the second connection state, the first route D1 and the fourth route D4 are connected, and the second route D2, and the third route D3 are connected. Specifically, in the first optical switch 20₁, the first optical fiber core 10₁ from the first route D1 which is connected to the port 1 on the input side is connected to the optical fiber 10₁₄ from the fourth optical switch 20₄ connected to the port 1-2 on the output side. In the fourth optical switch 20₄, the fourth optical fiber core 10₄ from the fourth route D4 which is connected to the port 4 on the input side is connected to the optical fiber 10₁₄ from the first optical switch 20₁ connected to a port 4-2 on the output side. Hence, the first route D1 and the fourth route D4 are connected through the first optical fiber core 10₁, the first optical switch 20₁, the optical fiber 10₁₄, the fourth optical switch 20₄, and the fourth optical fiber core 10₄.

In addition, in the second optical switch 20₂, the second optical fiber core 10₂ from the second route D2 which is connected to the port 2 on the input side is connected to the optical fiber 10₂₃ from the third optical switch 20₃ connected to the port 2-2 on the output side. In the third optical switch 20₃, the third optical fiber core 10₃ from the third route D3 which is connected to the port 3 on the input side is connected to the optical fiber 10₂₃ from the second optical switch 20₂ connected to a port 3-2 on the output side. Hence, the second route D2 and the third route D3 are connected through the second optical fiber core 10₂, the second optical switch 20₂, the optical fiber 10₂₃, the third optical switch 20₃, and the third optical fiber core 10₃.

Such switching to the second connection state may follow control signals transmitted to the first to fourth optical switches 20₁ to 20₄, similarly to the switching to the first connection state. In addition, the switching in the first optical switch 20₁ to the fourth optical switch 20₄ may be performed by driving the motor with the optically supplied electric power.

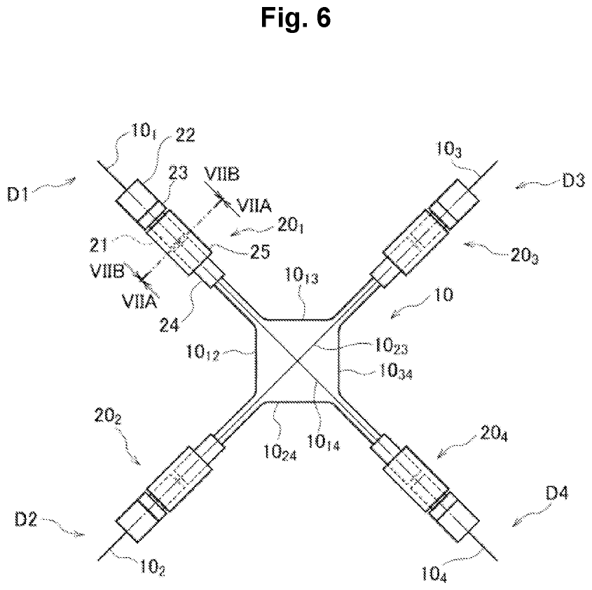

FIG. 6 is a view illustrating a schematic configuration of the optical cross-connect in the second connection state. In FIG. 6, the second connection state of the first to fourth optical switches 20₁ to 20₄ are indicated by alternate long and short dash lines. In FIG. 6, the first route D1 and the fourth route D4 are connected through the first optical fiber core 10₁, the first optical switch 20₁, the optical fiber 10₁₄, the fourth optical switch 20₄, and the fourth optical fiber core 10₄. In addition, the second route D2 and the third route D3 are connected through the second optical fiber core 10₂, the second optical switch 20₂, the optical fiber 10₂₃, the third optical switch 20₃, and the third optical fiber core 10₃.

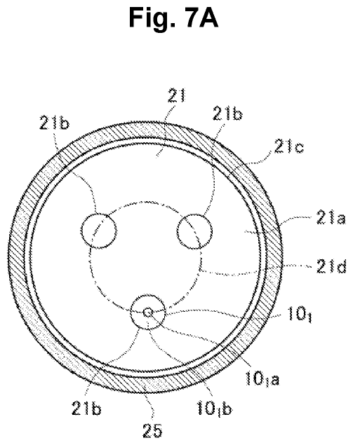

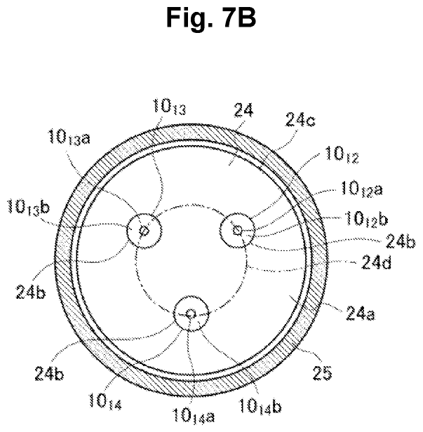

FIGS. 7A and 7B are cross-sectional views of the first optical switch 20₁ in the second connection state. FIGS. 7A and 7B illustrate cross sections of the first optical switch 20₁ cut along a cutting line passing between the end surface 21a of the first ferrule 21 and the end surface 24a of the second ferrule 24 which face each other inside the sleeve 25 in the first optical switch 20₁ in FIG. 6. FIG. 7A illustrates the end surface 21a of the first ferrule 21, and FIG. 7B illustrates the end surface 24a of the second ferrule 24.

In the first ferrule 21, the first optical fiber core 10₁ and the optical fiber 10₁₄ connected to the fourth optical switch 20₄ are abutted on each other and connected. In this case, the motor 22 rotatably drives the first ferrule 21, and the first optical fiber core 10₁ disposed at the end surface 21a of the first ferrule 21 abuts on the optical fiber 10₁₄ connected to the fourth optical switch 20₄ of the three optical fibers 10₁₂ to 10₁₄ disposed at the end surface 24a of the second ferrule 24. Since the end surface 21a of the first ferrule 21 illustrated in FIG. 7A is rotationally driven by the motor 22, it is recognized that the end surface 21a of the first ferrule 21 illustrated in FIG. 2A is rotated by 120 degrees.

Note that the optical cross-connect can perform switching to a third connection state in which the first route D1 and the second route D2 are connected and the third route D3 and the fourth route D4 are connected. Similarly to the first connection state and the second connection state, the third connection state can also be switched by appropriately setting the connection states in the first to fourth optical switches 20₁ to 20₄. For example, in the first optical switch 20₁, the first ferrule 21 may be rotated by 120 degrees in an appropriate direction from the first connection state illustrated in FIGS. 2A and 2B or the second connection state illustrated in FIGS. 7A and 7B. The same applies to the other second to fourth optical switches 20₂ to 20₄. Such switching to the third connection state may follow control signals transmitted to the first to fourth optical switches 20₁ to 20₄, similarly to the switching to the first and second connection states.

In the optical cross-connect of the present embodiment, the first ferrule 21 is rotationally driven by the motor 22 via the flange 23, but the present invention is not limited thereto. The first ferrule 21 may be manually rotated without providing the motor 22 and the flange 23. In addition, the second ferrule 24 is fixed in the rotation direction along the inner wall of the sleeve 25, but when the motor 22 or the like is not provided, the second ferrule 24 may be rotatable along the inner wall of the sleeve 25, or at least one of the first ferrule 21 and the second ferrule 24 may be manually rotated.

The first ferrule 21 and the second ferrule 24 of the present embodiment have the respective cylindrical side surfaces as illustrated in FIGS. 2A and 2B, but the present invention is not limited thereto. The side surfaces of the first ferrule 21 and the second ferrule 24 may have, for example, a prism shape such as a quadrangular prism shape and a hexagonal prism shape or may have other shapes. In the case where the side surfaces of the first ferrule 21 and the second ferrule 24 have the prism shape, the sleeve 25 may be formed of a flexible material such as a resin or rubber, and the inner wall of the sleeve may be formed in a shape corresponding to the prism shape of each of the side surfaces of the first ferrule 21 and the second ferrule 24. In this case, rotation angles of the first ferrule 21 and the second ferrule 24 and the sleeve 25 are set to predetermined angles by fitting. In the case where at least one of the first ferrule 21 and the second ferrule 24 is manually rotated without providing the motor, it is easy to set the rotation angle between the first ferrule 21 and the second ferrule 24.

As described above, in the optical cross-connect according to the present embodiment, when the optical signals from the four routes D1 to D4 are switched to each other, only the first ferrule 21 to which the first to fourth optical fiber cores 10₁ to 10₄ on the four routes D1 to D4 are connected is rotationally driven as a movable portion in the first to fourth optical switches 20₁ to 20₄. On the other hand, the second ferrule 24 is stationary even when the first ferrule 21 is rotationally driven. Therefore, the rotational driving of the first ferrule 21 does not affect the occurrence of entanglement or disconnection of the optical fibers 10₁₂ to 10₃₄ connected to the second ferrule 24 or fluctuations in optical loss. Hence, reliability of communication through the optical fibers 10₁₂ to 10₃₄ is ensured, and a highly reliable optical cross-connect with less loss fluctuation can be provided.

In addition, in the optical cross-connect of the present embodiment, the motor 22 can be driven by an optical power supply. Hence, even when the optical cross-connect is installed outdoors without a commercial power supply, the optical cross-connect can operate by the optical power transmitted from the communication station.

### REFERENCE SIGNS LIST

10₁ to 10₄ First to fourth optical fiber cores
10₁₂ to 10₃₄ Optical fiber
20 Optical switch
21 First ferrule
22 Motor
23 Flange
24 Second ferrule
25 Sleeve
D1 First route
D2 Second route
D3 Third route
D4 Fourth route

1. An optical cross-connect configured to switch connections between optical fiber cores on an even number of four or more routes, the optical cross-connect comprising:
optical switches connected to the respective optical fiber cores on the individual routes; and
optical fibers configured to connect the optical switches between each other, wherein
each of the optical switches includes
a first ferrule which is a ferrule disposed to expose each of the optical fiber cores at end surfaces and at which each of the optical fiber cores on a route that is connected to each of the optical switches is disposed,
a second ferrule which is the ferrule and at which each of the optical fibers that connect the optical switches between each other and are connected to the optical switches is disposed, and
a sleeve configured to support the first ferrule and the second ferrule inside such that the end surfaces of the first ferrule and the second ferrule face each other and the first ferrule and the second ferrule are rotatable relative to each other along an inner wall of the sleeve.

2. The optical cross-connect according to claim 1, wherein the ferrule is configured to arrange the optical fiber cores on a circumference formed at a circumferential edge of each of the end surfaces and on another circumference concentric with the circumference in each of the end surfaces, and the optical fiber cores are arranged at symmetrical positions in a circumferential direction.

3. The optical cross-connect according to claim 1, wherein the ferrule for disposing an optical fiber core has a hole which opens in each of the end surfaces to penetrate the ferrule, and each of the optical fiber cores is inserted into and fixed to the hole from a back side of each of the end surfaces.

4. The optical cross-connect according to claim 1, wherein the second ferrule is fixed in a rotation direction along the inner wall of the sleeve.

5. The optical cross-connect according to claim 1, further comprising a motor configured to rotatably drive the first ferrule along the inner wall of the sleeve such that an optical fiber core on a route which is disposed in the first ferrule is connected to one of optical fibers connecting the optical switches disposed in the second ferrule.

6. The optical cross-connect according to claim 5, wherein the motor is driven by electric power supplied by an optical power supply.

7. The optical cross-connect according to claim 1, further comprising a substrate configured to support the optical fibers that connect between the optical switches.

8. The optical cross-connect according to claim 1, wherein connections between 4-route optical fiber cores are switched.
